(19) United States
(12) Patent Application Publication
(10) Pub. No.: US 2012/0191428 A1
(43) Pub. Date: Jul. 26, 2012

(54) APPARATUS AND METHOD FOR PREDICTING TOTAL NITROGEN USING GENERAL WATER QUALITY DATA

(75) Inventors: Chang Won LEE, Osan-si (KR); Gwan Joong Kim, Daejeon (KR); Nae Soo Kim, Daejeon (KR); Pil Gyu Choi, Incheon (KR); Gun Bum Song, Anyang-si (KR); Hoon Jeong, Daejeon (KR); Young Hwan Ham, Daejeon (KR)

(73) Assignees: KOREA ENVIRONMENT CORPORATION, Incheon (KR); Electronics and Telecommunications Research Institute, Daejeon (KR)

(21) Appl. No.: 13/356,458

(22) Filed: Jan. 23, 2012

(30) Foreign Application Priority Data
Jan. 26, 2011 (KR) 10-2011-0007733

(51) Int. Cl. G06F 17/10

(52) U.S. Cl. 703/2

(57) ABSTRACT

An apparatus and method are provided, which predict total nitrogen using general water quality data measured in real time. The total nitrogen prediction apparatus may include a regression model selection unit to select a regression model comprising general data of at least one water quality based on a correlation coefficient of the general data of at least one water quality, a quality-of-fit evaluation unit to evaluate quality of fit of the selected regression model, a regression model change unit to determine whether to change the regression model based on the quality of fit and change the regression model according to the determination result, and a total nitrogen prediction unit to predict total nitrogen of a body of water based on the regression model.

### CROSS-REFERENCE TO RELATED APPLICATION

This application claims the benefit of Korean Patent Application No. 10-2011-0007733, filed on Jan. 26, 2011, in the Korean Intellectual Property Office, the disclosure of which is incorporated herein by reference.

### BACKGROUND

1. Field of the Invention

The present invention relates to an apparatus and method for predicting total nitrogen using general water quality data, and more particularly, to an apparatus and method for predicting total nitrogen of a body of water by selecting one of a plurality of regression models according to a correlation coefficient of water quality data being measured in real time.

2. Description of the Related Art

A total nitrogen measuring apparatus measures a total quantity of nitrogen, that is, total nitrogen included in a body of water to manage a pollution level of the body of water. Since a conventional total nitrogen measuring apparatus uses various reagents when measuring the total nitrogen, real-time measurement of the total nitrogen is impossible. In addition, the reagents need to be replenished for measurement of the total nitrogen.

Accordingly, there is a desire for a new method for measuring or predicting total nitrogen in a body of water in real time without reagents.

### SUMMARY

An aspect of the present invention provides an apparatus and method for predicting total nitrogen included in a body of water, capable of monitoring a change in the total nitrogen by generating a plurality of regression models and selecting one of the plurality of regression models based on a correlation coefficient of general water quality data being measured in real time, thereby predicting the total nitrogen.

Another aspect of the present invention provides an apparatus and method for predicting total nitrogen, capable of increasing accuracy of total nitrogen measurement by changing a regression model when quality of fit of the regression model selected based on a correlation coefficient of general water quality data is low, when predicting total nitrogen of a body of water.

Still another aspect of the present invention provides an apparatus and method for predicting total nitrogen, capable of preventing delay in measuring total nitrogen in a body of water according to a regression model, by predicting the total nitrogen using a predetermined default regression model when the regression model is changed more than a predetermined number of times.

According to an aspect of the present invention, there is provided a total nitrogen prediction apparatus including a regression model selection unit to select a regression model including general data of at least one water quality based on a correlation coefficient of the general data of at least one water quality, a quality-of-fit evaluation unit to evaluate quality of fit of the selected regression model, a regression model change unit to determine whether to change the regression model based on the quality of fit and change the regression model according to the determination result, and a total nitrogen prediction unit to predict total nitrogen of a body of water based on the regression model.

When the regression model is the single regression model, the regression model change unit may change the single regression model to the multi regression model. When the regression model is the multi regression model, the regression model change unit may change the multi regression model to the single regression model.

According to another aspect of the present invention, there is provided a total nitrogen prediction method including selecting a regression model including general data of at least one water quality based on a correlation coefficient of the general data of at least one water quality, evaluating quality of fit of the selected regression model, determining whether to change the regression model based on the quality of fit, and predicting total nitrogen of a body of water based on the regression model.

### EFFECT

According to embodiments of the present invention, a change in total nitrogen may be monitored by generating a plurality of regression models and selecting one of the plurality of regression models based on a correlation coefficient of general water quality data being measured in real time, thereby predicting the total nitrogen. Additionally, according to embodiments of the present invention, accuracy of total nitrogen measurement may be increased by changing a regression model when quality of fit of the regression model selected based on a correlation coefficient of general water quality data is low, when predicting total nitrogen of a body of water.

Additionally, according to embodiments of the present invention, delay may be prevented in measurement of total nitrogen in a body of water according to a regression model, by predicting the total nitrogen using a predetermined default regression model when the regression model is changed more than a predetermined number of times.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a total nitrogen prediction apparatus according to an embodiment of the present invention;

FIG. 2 is a flowchart illustrating a total nitrogen prediction method according to an embodiment of the present invention;

FIG. 3 is a diagram illustrating an example process of selecting a regression model and evaluating quality of fit of the regression model, according to an embodiment of the present invention;

FIG. 4 is a diagram illustrating an example process of determining whether to change the regression model, according to an embodiment of the present invention; and

FIG. 5 is a diagram illustrating an example process of changing a regression model according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

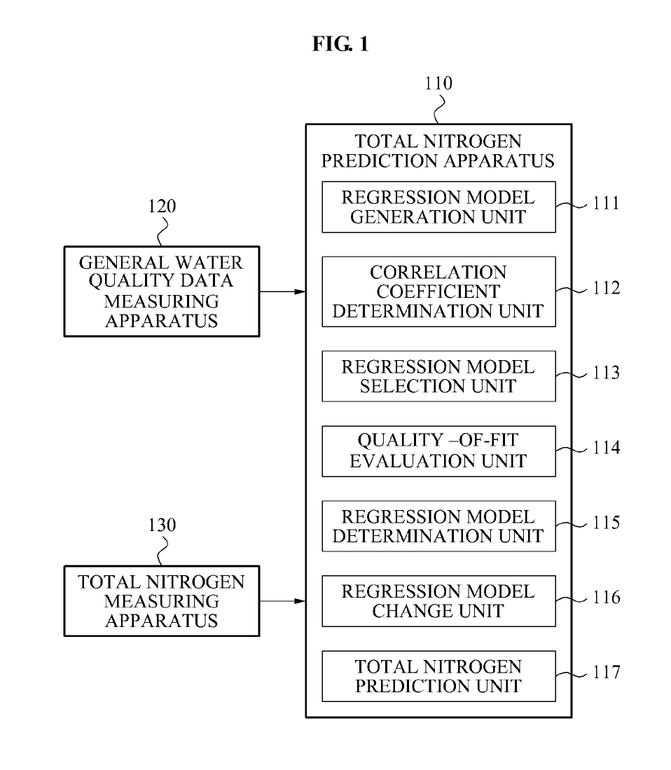

FIG. 1 is a block diagram illustrating a total nitrogen prediction apparatus 110 according to an embodiment of the present invention.

Referring to FIG. 1, the total nitrogen prediction apparatus 110 includes a regression model generation unit 111, a correlation coefficient determination unit 112, a regression model selection unit 113, a quality-of-fit evaluation unit 114, a regression coefficient determination unit 115, a regression model change unit 116, and a total nitrogen prediction unit 117.

The regression model generation unit 111 may generate a regression model that includes general water quality data based on actual total nitrogen that is actually measured by a total nitrogen measuring apparatus 130. The regression model generation unit 111 may generate at least one selected from a single regression model including one water quality, a multi regression model including general data of a plurality of water qualities, and a default regression model including a predetermined general water quality data. In particular, the regression model generation unit 111 may generate the single regression model including individual general water quality data and the multi regression model including the plurality of general water quality data, and then set the default regression model including general water quality data selected from the single regression model and the multi regression model. Here, the general water quality data may include at least one selected from a water temperature measured in real time, conductivity, chlorophyll, turbidity, dissolved oxygen (DO), hydrogen ion concentration (pH), and an oxidation reduction potential (ORP). In addition, the default regression model may include general water quality data likely to have a relatively high quality of fit among the regression models. For example, the default regression model may include at least one selected from the water temperature, the conductivity, and the DO.

Furthermore, when the actual total nitrogen actually measured by the total nitrogen measuring apparatus 130 is updated, the regression model generation unit 111 may regenerate the regression model including the general water quality data based on the updated actual total nitrogen.

The correlation coefficient determination unit 112 may determine a correlation coefficient between real-time general water quality data measured in real time by a water general quality data measuring apparatus 120 and the actual total nitrogen actually measured by the total nitrogen measuring apparatus 130. For example, the correlation coefficient determination unit 112 may apply the Pearson correlation analysis between the real-time general water quality data and the actual total nitrogen, to determine the correlation coefficient.

The regression model selection unit 113 may select a regression model including the general water quality data, based on the correlation coefficient determined by the correlation coefficient determination unit 112. That is, the regression model selection unit 113 may select general data of at least one water quality based on the correlation coefficient, and select a regression model including general data of the at least one selected water quality from the at least one regression model generated by the regression model generation unit 111. For example, when a correlation coefficient of general data of one water quality is higher than a correlation coefficient of general data of another water quality, the regression model selection unit 113 may select general data of the one water quality and also select the single regression model including general data of the one water quality. As another example, the regression model selection unit 113 may select general data of three water qualities having three highest correlation coefficients, and select the multi regression model including general data of the selected water quality.

The quality-of-fit evaluation unit 114 may evaluate quality of fit of the regression model selected by the regression model selection unit 113. For example, the quality-of-fit evaluation unit 114 may use analysis of variance (ANOVA) to evaluate the quality of fit. Here, the quality-of-fit evaluation unit 114 may calculate a determination coefficient using a least square method for a regression coefficient. Specifically, the quality-of-fit evaluation unit 114 may calculate the determination coefficient by performing the ANOVA based on at least one value generated by the least square method performed to determine the regression coefficient in the regression model.

The regression coefficient determination unit 115 may determine the regression coefficient by applying a regression model selected by the regression model selection unit 113 to the actual total nitrogen actually measured by the total nitrogen measuring apparatus 130 and to the general water quality data determined to have a high correlation coefficient by the correlation coefficient determination unit 112.

The regression model change unit 116 may determine whether to change the regression model selected by the regression model selection unit 113 based on the quality of fit evaluated by the quality-of-fit evaluation unit 114. When the regression model needs to be changed, the regression model change unit 116 may change the regression model. That is, the regression model change unit 116 may determine whether the regression model is appropriate for prediction of the total nitrogen based on the quality of fit and, if not appropriate, may determine that the regression model needs to be changed.

For example, the regression model change unit 116 may determine whether to change the regression model based on a result of comparison between a threshold value and the determination coefficient of the regression model calculated by the quality-of-fit evaluation unit 114. In this instance, the determination coefficient determines whether the regression model is appropriate. Here, an optimum value for the determination coefficient is 1. However, since the determination coefficient rarely satisfies the optimum value, the regression model change unit 116 may set the threshold value to be approximate to 1 based on an error range desired by a user or capability of the prediction apparatus. When the determination coefficient is less than or equal to the threshold value, the regression model change unit 116 may determine that the regression model does not need to be changed.

As another example, the regression model change unit 116 may determine whether to change the regression model based on whether linearity related to correlations among general water quality data of the regression model is satisfied. Here, when a change in general data of one of the water qualities selected by the regression model selection unit 113 causes a change in the other general water quality data by the same proportion, the regression model change unit 116 may determine that all general data of the water qualities of the regression model satisfy the linearity and therefore the corresponding regression model is inappropriate for prediction of the total nitrogen. In addition, when the general water quality data selected by the regression model selection unit 113 change independently, and are not influenced by the general data of the other water qualities, the regression model change unit 116 may determine that the corresponding regression model is appropriate for the prediction.

Furthermore, when the regression model to be changed is the single regression model, the regression model change unit 116 may change the regression model to the multi regression model. When the regression model to be changed is the multi regression model, the regression model change unit 116 may change the regression model to the single regression model.

That is, when the regression model to be changed is the single regression model, the regression model change unit 116 may select general data of a plurality of water qualities based on the correlation coefficient, and change the single regression model to the multi regression model that includes the general water quality data used for the regression model and the general water quality data selected based on the correlation coefficient. In addition, when the regression model to be changed is the multi regression model, the regression model change unit 116 may select general data of one of the water qualities constituting the multi regression model based on the correlation coefficient, and change the multi regression model to the single regression model that includes general data of the selected water quality.

To prevent a continuous change of the regression model, the regression model change unit 116 may change a regression model that has been changed more than a predetermined number of times, to the default regression model. For example, when the multi regression model changed from the single regression model needs to be changed again, the regression model change unit 116 may change the multi regression model to the default regression model. As another example, when the single regression model changed from the multi regression model needs to be changed again, the regression model change unit 116 may change the single regression model to the default regression model.

The regression coefficient determination unit 115 may recalculate the regression coefficient by applying the regression model changed by the regression model change unit 116.

The total nitrogen prediction unit 116 may predict the total nitrogen of a body of water, based on the regression model selected by the regression model selection unit 113 or the regression model changed by the regression model change unit 116.

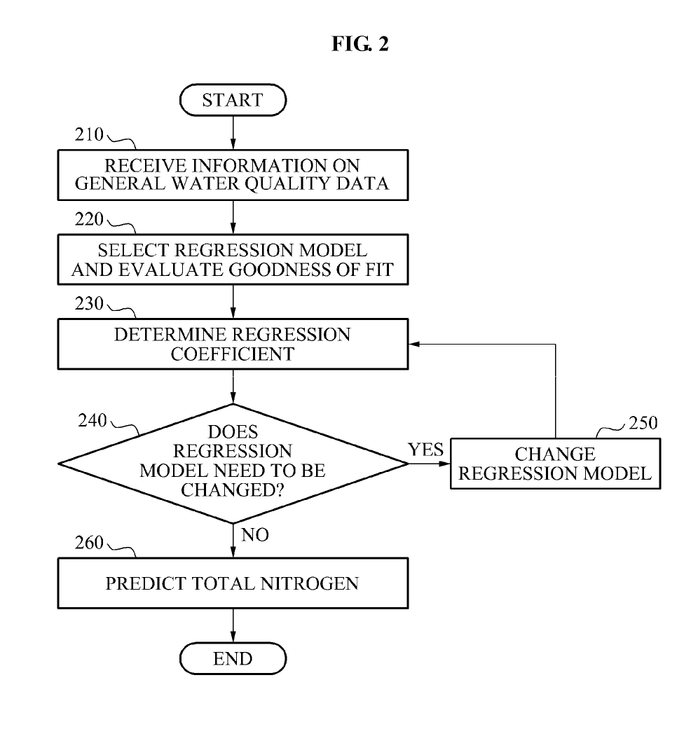

FIG. 2 is a flowchart illustrating a total nitrogen prediction method according to an embodiment of the present invention.

In operation 210, the correlation coefficient determination unit 112 may receive information on general water quality data measured in real time by the correlation coefficient determination unit 112.

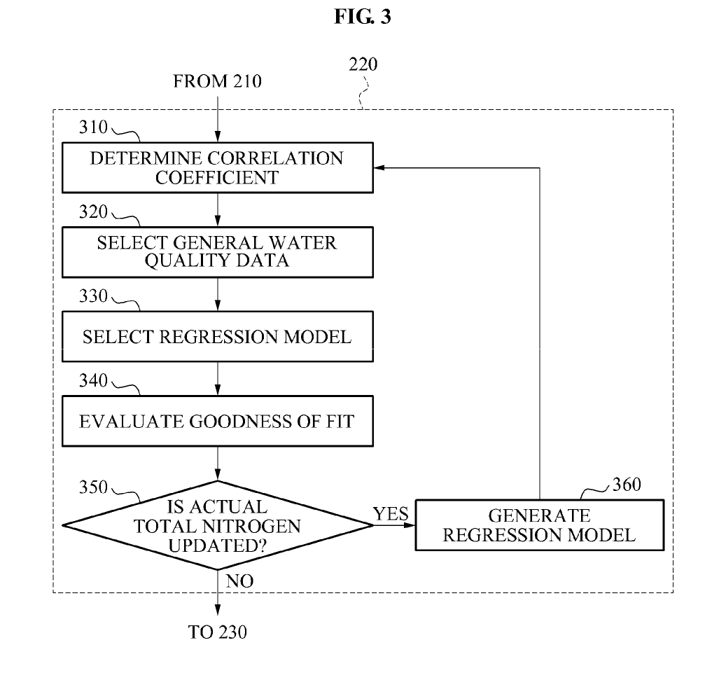

In operation 220, the regression model selection unit 113 may select the regression model including the general water quality data based on the correlation coefficient of the general water quality data received in operation 210, and evaluate quality of fit of the selected regression model. The selecting of the regression model by the regression model selection unit 113 will be described in detail with reference to FIG. 3.

In operation 230, the regression model determination unit 115 may determine the correlation coefficient by performing a multiple linear regression analysis applying the regression model selected in operation 220 to the actual total nitrogen actually measured by the total nitrogen measuring apparatus 130.

In operation 240, the regression model change unit 116 may determine whether to change the regression model selected in operation 220, based on the quality of fit evaluated in operation 220. Here, when the regression model is determined to be changed, the regression model change unit 116 may change the regression model in operation 250.

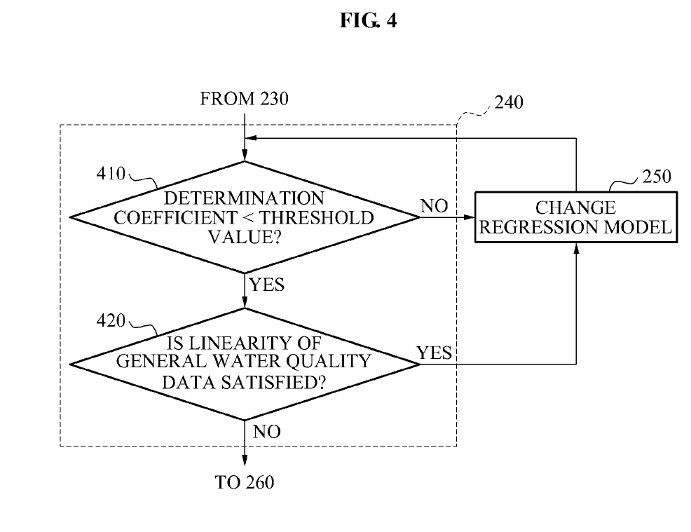

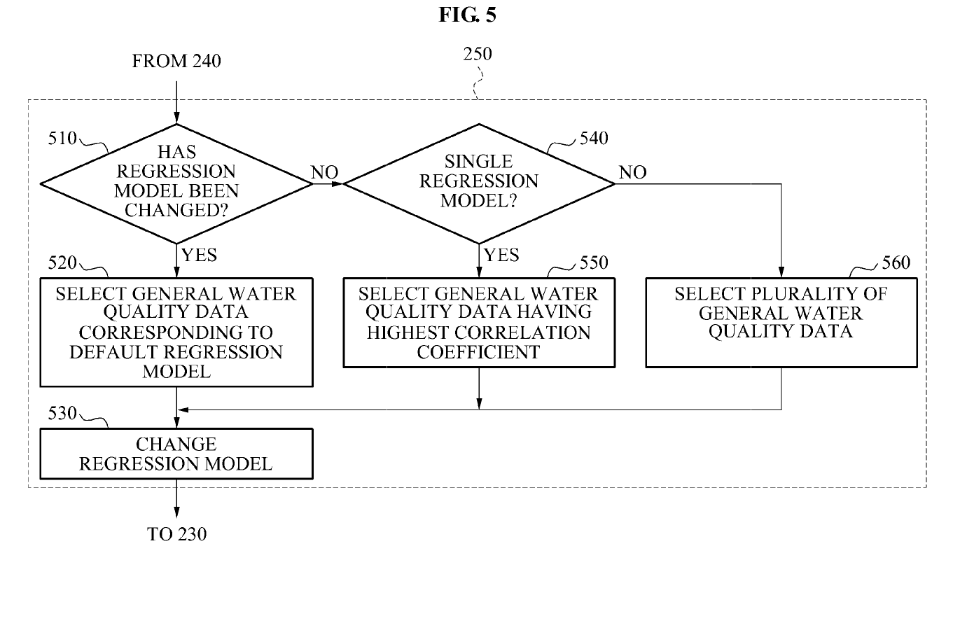

A process of determining whether to change the regression model will be described in detail with reference to FIG. 4. In addition, a process of changing the regression model will be described in detail with reference to FIG. 5.

In operation 260, the total nitrogen prediction unit 117 may predict the total nitrogen based on the regression model selected in operation 220 or the regression model changed in operation 250.

FIG. 3 is a diagram illustrating an example process of selecting a regression model and evaluating quality of fit of the regression model, according to an embodiment of the present invention. Here, operations 310 to 360 may be included in operation 220 illustrated in FIG. 2.

In operation 310, the correlation coefficient determination unit 112 may determine the correlation coefficient of general data of each water quality received in operation 210. For example, the correlation coefficient determination unit 112 may apply the Pearson correlation analysis to the actual total nitrogen predicted by the total nitrogen prediction unit 117 and the respective general data of water quality, to determine the correlation coefficient.

In operation 320, the regression model selection unit 113 may select general data of at least one water quality based on the correlation coefficient determined in operation 310.

In operation 330, the regression model selection unit 113 may select the regression model that includes the general data of the water quality selected in operation 320, from the regression models generated by the regression model generation unit 111.

In operation 340, the quality-of-fit evaluation unit 114 may evaluate the quality of fit of the regression model selected in operation 330. For example, the quality-of-fit evaluation unit 114 may evaluate the quality of fit using ANOVA.

In operation 350, the regression model generation unit 111 may confirm whether the actual total nitrogen actually measured by the total nitrogen measuring apparatus 130 is updated. For example, the total nitrogen measuring apparatus 130 may update the total nitrogen by measuring the total nitrogen of the water body once per hour.

In operation 360, the regression model generation unit 111 may regenerate the regression model that includes the general water quality data based on the actual total nitrogen confirmed to be updated in operation 350. In this instance, the regression model generation unit 111 may generate at least one selected from the single regression model including one water quality, the multi regression model including a plurality of the general water quality data, and the default regression model including the predetermined general water quality data.

FIG. 4 is a diagram illustrating an example process of determining whether to change the regression model, according to an embodiment of the present invention. Here, operations 410 and 420 may be included in operation 240 illustrated in FIG. 2.

In operation 410, the regression model change unit 116 may determine that the regression model does not need to be changed, when the determination coefficient of the regression model calculated during evaluation of the quality of fit in operation 220 is less than equal to the threshold value, and therefore proceed with operation 420.

In operation 420, the regression model change unit 116 may determine whether to change the regression model based on whether linearity among the general water quality data of the regression model is satisfied. Here, when a change in one of the general water quality data selected by the regression model selection unit 113 causes a change in the other general water quality data by the same proportion, the regression model change unit 116 may determine that all of the general water quality data of the regression model satisfies the linearity and as a consequence the corresponding regression model is inappropriate for prediction of the total nitrogen, accordingly proceeding with operation 250.

FIG. 5 is a diagram illustrating an example process of changing a regression model according to an embodiment of the present invention. Here, operations 510 to 560 may be included in operation 250 illustrated in FIG. 2.

In operation 510, the regression model change unit 116 may determine whether the regression model determined to be changed in operation 240 has been changed before. That is, to prevent a continuous change of the regression model, the regression model change unit 116 may determine whether the regression model determined to be changed in operation 240 is the regression model selected in operation 220 or the regression model changed in operation 250.

When the regression model is determined to be the regression model changed in operation 250 in operation 510, the regression model change unit 116 may select general water quality data corresponding to the default regression model in operation 520, and change the regression model to the default regression model, in operation 530.

In operation 540, the regression model change unit 116 may determine whether the regression model selected in operation 220 is the single regression model.

When the regression model selected in operation 220 is not the single regression model but the multi regression model, the regression model change unit 116 may select one of the general water quality data constituting the multi regression model based on the correlation coefficient in operation 550, and may change the multi regression model to the single regression model that includes the general water quality data selected in operation 530.

In addition, when the regression model selected in operation 220 is the single regression model, the regression model change unit 116 may select general data of a plurality water qualities based on the correlation coefficient in operation 560, and change the single regression model to the multi regression model that includes the general water quality data used for the single regression model and the general water quality data selected in operation 560, in operation 530.

According to the embodiments of the present invention, total nitrogen of a body of water is predicted by generating a plurality of regression models and selecting one of the plurality of regression models according to a correlation coefficient of general water quality data being measured in real time. Therefore, a change in the total nitrogen may be monitored.

Furthermore, when quality of fit of the selected regression model is low, the total nitrogen may be predicted by changing the regression model. As a result, accuracy of the predicted total nitrogen may be increased. In addition, when the regression model is changed more than a predetermined number of times, a predetermined default regression model may be used for prediction of the total nitrogen. Therefore, delay in prediction of the total nitrogen caused by the change of the regression model may be prevented.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A total nitrogen prediction apparatus comprising:
a regression model selection unit to select a regression model comprising general data of at least one water quality based on a correlation coefficient of the general data of at least one water quality;
a quality-of-fit evaluation unit to evaluate quality of fit of the selected regression model;
a regression model change unit to determine whether to change the regression model based on the quality of fit and change the regression model according to the determination result; and
a total nitrogen prediction unit to predict total nitrogen of a body of water based on the regression model.

2. The total nitrogen prediction apparatus of claim 1, wherein the regression model comprises at least one selected from a single regression model comprising one general water quality data, a multi regression model comprising general data of a plurality of water qualities, and a default regression model comprising a predetermined general water quality data.

3. The total nitrogen prediction apparatus of claim 2, wherein the general water quality data comprises at least one selected from a water temperature, conductivity, chlorophyll, turbidity, dissolved oxygen (DO), hydrogen ion concentration (pH), and an oxidation reduction potential (ORP).

4. The total nitrogen prediction apparatus of claim 3, wherein the default regression model comprises at least one selected from the water temperature, the conductivity, and the DO.

5. The total nitrogen prediction apparatus of claim 1, wherein the regression model change unit determines whether to change the regression model based on a result of comparison between a determination coefficient of the regression model and a threshold value.

6. The total nitrogen prediction apparatus of claim 1, wherein the regression model change unit determines whether to change the regression model based on linearity related to a correlation of the general water quality data of the regression model.

7. The total nitrogen prediction apparatus of claim 2, wherein the regression model change unit changes the single regression model to the multi regression model.

8. The total nitrogen prediction apparatus of claim 2, wherein the regression model change unit changes the multi regression model to the single regression model.

9. The total nitrogen prediction apparatus of claim 2, wherein the regression model change unit changes a regression model to the default regression model when the regression model is changed more than a predetermined number of times.

10. The total nitrogen prediction apparatus of claim 1, further comprising:
a regression model generation unit to generate regression models comprising the general water quality data based on actual total nitrogen actually measured by a total nitrogen measuring apparatus; and
a correlation coefficient determination unit to determine the correlation coefficient of the general water quality data measured in real time by a general water quality data measuring apparatus,
wherein the regression model selection unit selects general data of at least one water quality based on the correlation coefficient, and selects a regression model comprising general data of the selected water quality from the regression models.

11. A total nitrogen prediction method comprising:
selecting a regression model comprising general data of at least one water quality based on a correlation coefficient of the general data of at least one water quality;
evaluating quality of fit of the selected regression model;
determining whether to change the regression model based on the quality of fit; and
predicting total nitrogen of a water body based on the regression model.

12. The total nitrogen prediction method of claim 11, wherein the regression model comprises at least one selected from a single regression model comprising one general water quality data, a multi regression model comprising general data of a plurality of water qualities, and a default regression model comprising a predetermined general water quality data.

13. The total nitrogen prediction method of claim 12, wherein the general water quality data comprises at least one selected from a water temperature, conductivity, chlorophyll, turbidity, dissolved oxygen (DO), hydrogen ion concentration (pH), and an oxidation reduction potential (ORP).

14. The total nitrogen prediction method of claim 13, wherein the default regression model comprises at least one selected from the water temperature, the conductivity, and the DO.

15. The total nitrogen prediction method of claim 11, wherein the determining of the change comprises:
determining whether to change the regression model based on a result of comparison between a determination coefficient of the regression model and a threshold value.

16. The total nitrogen prediction method of claim 11, wherein the determining of the change comprises:
determining whether to change the regression model based on linearity related to a correlation of the general water quality data of the regression model.

17. The total nitrogen prediction method of claim 12, wherein the changing of the regression model comprises:
changing the single regression model to the multi regression model.

18. The total nitrogen prediction method of claim 12, wherein the changing of the regression model comprises:
changing the multi regression model to the single regression model.

19. The total nitrogen prediction method of claim 12, wherein the changing of the regression model comprises:
changing a regression model to the default regression model when the regression model is changed more than a predetermined number of times.

20. The total nitrogen prediction method of claim 11, further comprising:
generating regression models comprising the general water quality data based on actual total nitrogen actually measured by a total nitrogen measuring apparatus; and
determining the correlation coefficient of the general water quality data measured in real time by a general water quality data measuring apparatus,
wherein the selecting of the regression model comprises:
selecting at least one general water quality data based on the correlation coefficient; and
selecting a regression model comprising the selected general water quality data from the regression models.
